(19) United States
(12) Patent Application Publication
(10) Pub. No.: US 2023/0175582 A1
(43) Pub. Date: Jun. 8, 2023

(54) Coupling Device for a Motor Vehicle

(71) Applicant: ZF Friedrichshafen AG, Friedrichshafen (DE)

(72) Inventors: Elena Wendel, Tettnang (DE); Florian Schneider, Lindenberg im Allgäu (DE); Andreas Schmidt, Ravensburg (DE); Wilfrid Eberhard, Tettnang (DE)

(21) Appl. No.: 18/073,301

(22) Filed: Dec. 1, 2022

(30) Foreign Application Priority Data
Dec. 2, 2021 (DE) 10 2021 213 655.9

(51) Int. Cl. F16H 61/04

(52) U.S. Cl. CPC F16H 61/0403; F16H 2061/047

(57) ABSTRACT

A coupling device for a motor vehicle includes a first coupling element associated with a first rotatable part of the motor vehicle, and a second coupling element associated with a second rotatable part of the motor vehicle. The coupling device moves one or both of the first coupling element and the second coupling element into an intermediate position before a target rotational speed differential between the first and the second coupling elements is reached. Specifically, the target rotational speed differential is reached before the coupling device moves the first coupling element and the second coupling element into form-lockingly coupling to couple the first and second rotatable parts.

### CROSS-REFERENCE TO RELATED APPLICATION

The present application is related and has right of priority to German Patent Application No. 10 2021 213 655.9 filed on Dec. 2, 2021, the entirety of which is incorporated by reference for all purposes.

### FIELD OF THE INVENTION

The present subject matter relates generally to a coupling device for a motor vehicle, the coupling device including a first coupling element, which is associated with a first rotating or rotatable part, and a second coupling element, which is associated with a second rotating or rotatable part, wherein the coupling device is usable for setting a target rotational speed between the first and the second coupling elements and form-lockingly coupling the first coupling element and the second coupling element.

### BACKGROUND

Coupling devices for motor vehicles, where the coupling devices are for detachably coupling two rotating or rotatable parts to each other, are known, in principle, from the prior art. A coupling device of this type couples, for example, an idler gear to a shaft, two idler gears to each other, or two shafts to each other, and release the coupling when the particular sub-train of the drive train is to be decoupled. In principle, any and all rotatable parts of a transmission device are therefore detachably coupleable. For example, the coupling device is usable for this purpose within the scope of a so-called “disconnect unit” to decouple a part of the drive train, for example, when fuel and CO₂ are to be saved, when the part to be decoupled is not needed for the current driving situation.

In particular with respect to the coupling of the two parts, it is known that a target rotational speed or target rotational speed differential must be set between the two coupling elements, so that the form-locking coupling is established. For this purpose, the target rotational speed is usually selected to be slightly deviating from an equality of rotational speed, in order to enable a release of tooth-on-tooth positions, if they arise, by a slight relative turn of the coupling elements. In other words, one coupling element is usually moved toward the other coupling element, in order to bring the teeth or claws of the coupling elements into engagement. For this purpose, the differential speed or speed differential between the two coupling elements is monitored and the movement of the movable coupling element is initiated when the adapted rotational speed exceeds a certain rotational speed threshold. In other words, in order to carry out the coupling process, the input-side rotational speed is usually matched to the rotational speed of the output, so that the coupling device is engageable or the engagement process is initiated when the matching has been nearly concluded.

A so-called “response time”, i.e., the time that elapses from the initiation of the coupling process up to an actual movement of the movable coupling element, and a so-called “time-of-flight”, i.e., the time that the coupling element needs to move into the coupled condition, are usually taken into account in this case. In other words, the initiation of the coupling process or the movement of the coupling element is matched to the progression of the adaptation of the rotational speed to the target rotational speed. Driving situations are known, however, in which the rotational speed spontaneously and significantly changes, in particular on the output side, such that the previously adapted coupling process is no longer carried out at the desired target rotational speed. If, for example, a comparatively strong braking operation is carried out, the rotational speed of the output side changes such that the adaptation to the target rotational speed deviates from the original process. If the movement of the coupling element has already been initiated in this condition, the coupling process is no longer optimally performable. In the worst case, the coupling element is repelled during the coupling, acoustic deviations occur, or a tooth-on-tooth position arises, which must be released before the coupling, and so the shift time is prolonged.

### SUMMARY OF THE INVENTION

An improved coupling device for a motor vehicle is disclosed herein.

As described above, a coupling device for a motor vehicle includes a first and a second coupling element. One of the two coupling elements is movable in order to establish a form-locking coupling between the first coupling element and the second coupling element. For example, a first coupling element is understood to be a movable dog that is to be coupled to a second coupling element formed as a coupling body. Within the scope of this application, the terms “first” and “second” are therefore arbitrarily interchangeable or transferrable. Within the scope of this application, reference is therefore made, in general, to a “movable coupling element,” wherein the description is arbitrarily transferrable to a first coupling element, a second coupling element, or both coupling elements. The movement of the movable coupling element is generated by an appropriate actuator. In principle, the actuator is any suitable actuator. Within the scope of this application, it is particularly advantageous when the actuator is an electro-mechanical actuator, since this improves the movement of the movable coupling element.

The coupling device brings the first and/or the second coupling element(s) into at least one intermediate position before the target rotational speed has been reached. By bringing the movable coupling element, i.e., for example, the first and/or the second coupling element(s), into the intermediate position, the “time-of-flight” for moving the moving coupling element into the coupled position is reducible. In other words, the movable coupling element is moved already before the target rotational speed has been reached, namely into an intermediate position, which is situated closer to the coupled position of the movable coupling element than the starting position. In this context, for example, a starting position is defined, in which the coupling device is in the decoupled condition. Moreover, an end position is defined, in which the coupling device is in the completely coupled condition.

The intermediate position is situated, as is apparent, between the starting position and the end position, such that the movable coupling element in the intermediate position has already been moved in the direction of the particular other coupling element. The remaining distance that the movable coupling element must therefore cover is shortened by the distance already separating the intermediate position from the starting position.

Finally, the coupling element therefore only needs to cover a shortened distance, so that negative effects on the rotational-speed adaptation no longer occur across the entire distance between the starting position and the end position. Instead, the time that is still needed for the coupling process is significantly shortened.

The target rotational speed that is used within the scope of this application is, in particular, a rotational speed deviating from an equality of rotational speed. For example, the target rotational speed can deviate from an equality of rotational speed between the first and the second coupling elements by 10 rpm. The coupling is, in particular, “pre-synchronous.” A small speed differential between the rotational speed of the first coupling element and the rotational speed of the second coupling element is therefore set as the target rotational speed. Here, in particular, the rotational speed of the input-side coupling element is matched to the rotational speed of the output-side coupling element or the rotational speed of the input-side coupling element is adapted such that the desired target rotational speed sets in between the first and the second coupling elements. In addition, it is also possible to aim for an equality of rotational speed between the two coupling elements as the target rotational speed.

Moreover, the coupling device is refined such that the coupling device moves the first and/or the second coupling element(s) into precisely one intermediate position in preparation for the coupling process before the target rotational speed has been reached. The intermediate position is settable, for example, such that a distance still to be covered for the coupling is as small as possible. However, the intermediate position is selected such that an unintentional premature coupling is also ruled out if tolerances arise in the component dimensions or in the positioning of the coupling elements. The intermediate position is assumed, for example, when a coupling process is pending, although before the coupling process is initiated or carried out. If the coupled condition is to be established by the coupling device, for example, within the scope of the driving strategy or the operating situation, the movable coupling element is brought into the intermediate position already in advance, in order to need to cover only the shortest distance possible upon initiation of the coupling process.

The above-described intermediate position is, for example, fixedly predefined. The intermediate position is predefined by measurement or detection or by definition. For example, a deviation or an “offset” is taken into account, in order to always ensure that the movable coupling element in the intermediate position has no contact to the other coupling element. It is also possible to regularly check and, if necessary, adjust the intermediate position, for example, to compensate for wear or deviations in the coupling device.

According to some embodiments of the coupling device, it is provided that the coupling device moves the first and/or the second coupling element(s) as a function of the speed differential in preparation for the coupling process before the target rotational speed has been reached. According to such embodiments, multiple intermediate positions are provided, into which the movable coupling element is movable. In particular, a synchronous movement of the movable coupling element is achievable, in which the position of the coupling element is set directly as a function of the current speed differential. In other words, the movable coupling element is brought that much closer to the particular other coupling element, the more closely the current speed differential approaches the target rotational speed. If the speed differential moves away from the target rotational speed, the movable coupling element is brought correspondingly farther away from the other coupling element.

It is possible, in particular, that the position, the speed, and the change in the position or the change in the speed of the movable coupling element is changed or set in proportion to the speed differential or the change in the speed differential. In particular, it is provided that the movable coupling element is moved toward the other coupling element for as long as it takes for the current speed differential to approach the target rotational speed. If the current speed differential finally corresponds to the target rotational speed, the coupling is completely established. In this case, in particular, the situation is avoidable in which a deviation in the speed differential, for example, due to an abrupt deceleration of the motor vehicle, results in the coupling process still being carried out, since, in such a case, the movement of the movable coupling element is changed in accordance with the changing speed differential. If the speed differential abruptly changes, for example, a movement of the coupling element is interruptible or correctable.

The coupling device is usable for detecting the speed differential of the two coupling elements and connecting the coupling elements when a limit speed has been reached or fallen below. In other words, a limit speed is defined, which must be reached or fallen below, in order to finally initiate the coupling process. As described above, the movable coupling element is moved already into the at least one intermediate position or toward the other coupling element synchronously with the change in the speed differential or the approach to the target rotational speed. If the limit speed is finally exceeded, in particular, a remaining deviation from the target rotational speed is fallen below, the coupling process is finally carried out by the movable coupling element being moved by the actuator toward the other coupling element until the coupling is established. Since the two coupling elements, as described above, have already approached each other, it is no longer necessary to stop the coupling element or to decelerate the coupling element. Instead, the actuator carries out a continuous movement of the coupling element into the coupled position, which positively affects the shift time.

Moreover, the coupling device is usable for correcting a movement of at least one coupling element and/or at least one intermediate position of at least one coupling element, in particular as a function of the speed differential of the coupling elements. As described above, the at least one movable coupling element is placeable or movable as a function of the speed differential between the two coupling elements. The movement is appropriately paused or decelerated or accelerated. It is also possible to move the coupling element in the coupling direction and in the decoupling direction, in order to adapt the current intermediate position of the coupling element, for example, continuously, to the current speed differential between the two coupling elements. If a strong deceleration of the motor vehicle takes place, the at least one movable coupling element is appropriately movable away from the other coupling element again. The correction of the intermediate position of the movable coupling element is carried out, in particular, for as long as it takes until the limit speed has been reached and the engagement process is carried out.

According to further example aspects, the coupling device is usable to detect at least one position of the first coupling element and/or of the second coupling element. In particular, the coupling device is usable to detect the position of the movable coupling element. The detection either actively takes place, for example, via a position sensor at the at least one movable coupling element, or by various detection methods, for example, by detecting a tooth-on-tooth position and, thus, indirectly determining the position.

For example, an actuator is usable for detecting the position of the coupling element, for example, by counting the revolutions in the case of an electro-mechanical actuator. In this case, in particular, a fixed intermediate position is initially assumed, into which the movable coupling element is brought before the target rotational speed has been reached. When the position detection of the movable coupling element is present, the continuous movement of the coupling element is carried out as a function of the speed differential. It is ensured, in particular, that the position of the movable coupling element is always correctly known, so that an unintentional premature engagement of the coupling device is ruled out. The position of the coupling element is redetected at defined time intervals or in an event-based manner, for example, after a certain number of operating hours or engagement processes or ignition routines.

Moreover, the coupling device is usable for detecting an arising dog intermediate condition of the coupling elements, in particular a dog clamping or a tooth-on-tooth position, and moving at least one coupling element as a function of the dog intermediate condition. It is provided, in particular, that a movement of the movable coupling element is carried out in a dog intermediate condition arising despite the above-described engagement process, in order to release the dog intermediate condition. The movement of the coupling element is controllable by the coupling device based on which type of dog intermediate condition is present. In a dog intermediate condition in the form of dog clamping, i.e., when the dogs of the first coupling element jam into the dogs of the second coupling element, the actuation force is increasable, i.e., the actuator presses the movable coupling element into the dogs of the other coupling element with a greater engagement force. In the case of a detected dog intermediate condition that has been identified as a tooth-on-tooth position, the actuation force is initially reducible, in order to simplify a rotation of the two coupling elements in relation to each other, in order to accelerate the release of the tooth-on-tooth position. Thereafter, the coupling is established by increasing the actuation force.

A motor vehicle may include the above-described coupling device.

A method for coupling two coupling elements of a coupling device for a motor vehicle, is also disclosed, wherein a target rotational speed is set between a first coupling element, which is associated with a first rotating or rotatable part of the motor vehicle, and a second coupling element, which is associated with a second rotating or rotatable part of the motor vehicle, and the first coupling element and the second coupling element are form-lockingly coupled, wherein the first and/or the second coupling element(s) are/is brought into at least one intermediate position before the target rotational speed has been reached. All advantages, details, and features that have been described with respect to the coupling device are completely transferrable to the motor vehicle and the method. The above-described coupling device is usable, in particular, for carrying out the method.

### BRIEF DESCRIPTION OF THE DRAWINGS

The invention is explained in the following on the basis of exemplary embodiments with reference to the figures. The figures are schematic views, wherein:

FIG. 1 shows an exemplary engagement process according to the prior art;

FIG. 2 shows an exemplary engagement process according to first exemplary aspects;

FIG. 3 shows an exemplary engagement process according to second exemplary aspects;

FIG. 4 shows an exemplary engagement process according to third exemplary aspects; and

FIG. 5 shows an exemplary engagement process according to fourth exemplary aspects.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

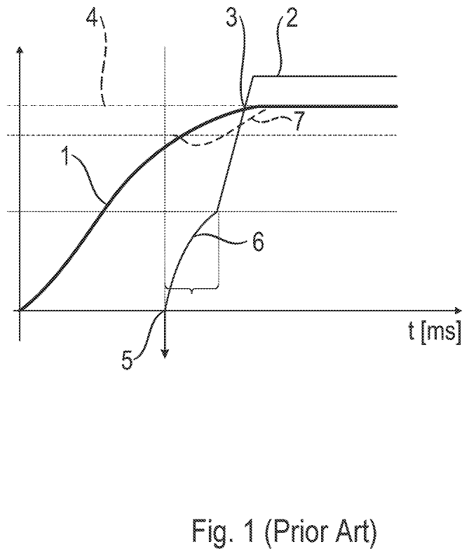

FIG. 1 shows an exemplary engagement process of a coupling device according to the prior art. The schematic diagram shows a curve 1 of the rotational speed of the movable coupling element of the coupling device or of the speed differential between two coupling elements of the coupling device, and a curve 2 of the displacement travel of the at least one movable coupling element. The rotational speed according to curve 1 is adapted to a target rotational speed 3 in order to engage the coupling device. The target rotational speed 3 provides a certain, in particular minor, relative rotation between the two coupling elements. A movable dog and a coupling body, in particular, is usable as the coupling element, for example, at a wheel or a shaft of a transmission of the motor vehicle. Either the speed differential between the two coupling elements, which speed differential is to be reduced to the target rotational speed 3, is considered or, as shown, the rotational speed of one of the coupling elements, in particular a coupling element in the decoupled condition, is accelerable to a defined rotational speed, in particular on the input side, so that the target rotational speed sets in between the two coupling elements.

As shown, the rotational speed of the coupling element increases according to curve 1 in order to carry out the engagement process at a planned point in time, i.e., to reach the target rotational speed 3, in particular shortly before a synchronous speed 4 has been reached, in order to be able to engage the coupling device. The above-described engagement process or coupling process is plannable by a control device, for example, in conformance with a driving strategy or shift strategy, or the like. In order to reach the target rotational speed 3 at the appropriate point in time, the movable coupling element is activated at a point in time 5 or the coupling process is begun at the point in time 5. The movable coupling element therefore carries out a movement 6 starting at the point in time 5, wherein a response time and a time-of-flight of the movable coupling element initially elapse until the movable coupling element reaches the other coupling element. The response time indicates, in particular, the time that elapses until the movable coupling element begins to move, and the time-of-flight indicates how long the movable coupling element needs to reach the toothing of the other coupling element, in particular to reach a tooth-on-tooth position.

In the operating situation shown, a deviation 7 is represented, which changes the speed differential between the two coupling elements. For example, the deviation 7 is generated by a strong brake engagement, which results in a change in the rotational speed on the output side, i.e., the rotational speed of the particular other coupling element. Since the deviation 7 arises after the point in time 5, the movement of the movable coupling element has already been initiated, and so the coupling element is ultimately no longer stoppable. As a result, the target rotational speed 3 has not been reached when the toothing of the other coupling element is reached, and so the coupling process is not optimally performable.

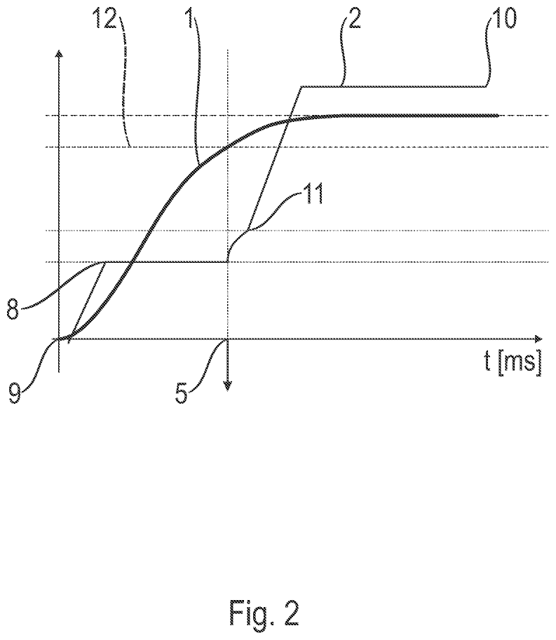

In order to improve the coupling process, it is provided, as shown in FIGS. 2-5, to assume an intermediate position 8, in order to reduce or avoid effects and deviations. In the schematic diagrams from FIGS. 2-5, the rotational speed according to curve 1 and the actuating travel or the position of the movable coupling element according to curve 2 are plotted with respect to time. If a coupling process is to be carried out, the movable coupling element is initially moved to an intermediate position 8, which is situated between a starting position 9, in which the coupling device is completely disengaged, and an end position 10, in which the coupling device is completely engaged. Starting from the intermediate position 8, a tooth-on-tooth position 11 for the movable coupling element is considerably closer and, thus, is reachable considerably faster. In other words, the distance and the movement time in which deviations 7 (shown in FIG. 1) have a negative effect on the coupling process are considerably shortened.

In other words, the movable coupling element is already moved closer to the other coupling element, in order to subsequently carry out the coupling process and engage the coupling device, in particular upon exceedance of a limit speed 12 or upon falling below a defined limit value for the speed differential. A considerably shorter distance is to be covered between the intermediate position 8 and the tooth-on-tooth position 11 than from the starting position 9 into the tooth-on-tooth position 11.

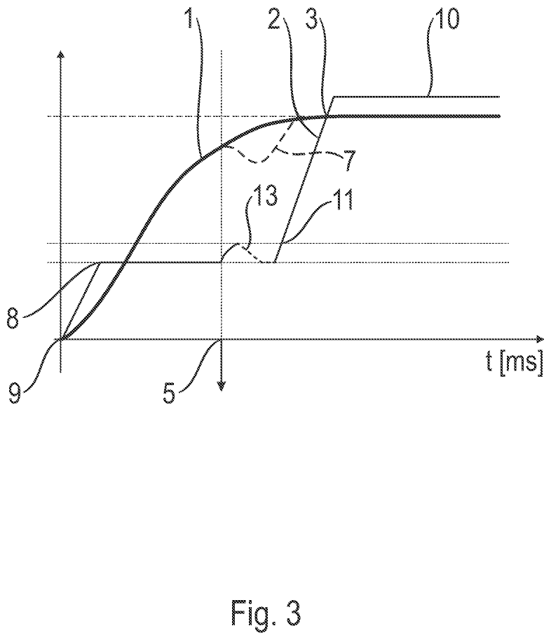

FIG. 3 shows the method described above with reference to FIG. 2 and the above-described coupling process when a deviation 7 arises. If, for example, starting at the point in time 5, an engagement process is initiated by the movable coupling element being moved starting from the intermediate position 8 toward the corresponding further coupling element, a correction 13 of the actuating travel or of the position of the movable coupling element is performable if the deviation 7 arises. The correction 13 is represented in this example as a movement of the movable coupling element in the decoupling direction. In other words, in this example, the movable coupling element 7 is moved back in the direction of the starting position 9 to the intermediate position 8 due to the deviation 7. Finally, with the correction 13, the movement of the movable coupling element is able to be paused, decelerated, accelerated, or, as shown, reversed.

If, for example, after the point in time 5, the speed differential between the coupling elements is changed in an unplanned manner due to a strong brake engagement, as is also described with reference to FIG. 1, the coupling element is movable back to the intermediate position 8 until the limit speed is exceeded, instead of carrying out the coupling process. The movable coupling element is movable from the intermediate position 8, as described above, into the end position 10, so that the target rotational speed 3 is reachable upon engagement of the coupling device.

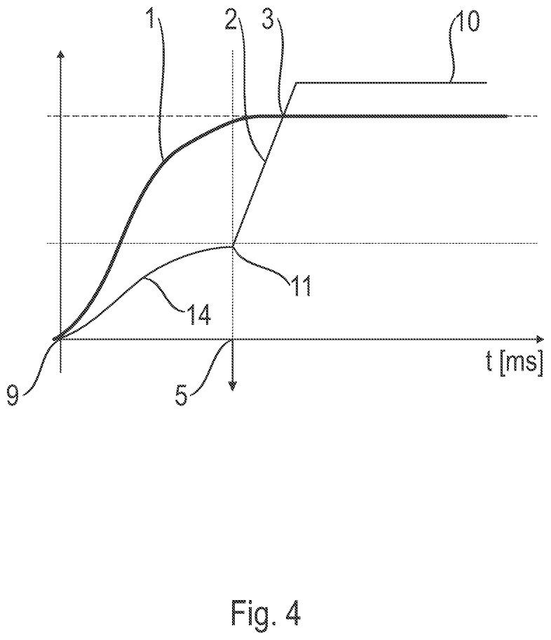

FIG. 4 shows the above-described method according to third example aspects. As shown, the movable coupling element is moved as a function of the speed differential between the two coupling elements. In a section 14 of the curve 2, it is apparent that the movable coupling element is movable in synchronism with the change in the speed differential between the coupling elements. This means an approach of the movable coupling element toward the further coupling element is also carried out during a synchronization of the two rotational speeds, i.e., during an adaptation of the speed differential in the direction of the target rotational speed 3. This means the movable coupling element is movable closer and closer to the further coupling element, provided the rotational speeds of the two coupling elements are synchronized or approach the target rotational speed 3. As shown in FIG. 4, the movable coupling element is therefore movable in the direction of the tooth-on-tooth position 11. The position, the speed, and the change in the position and the change in the speed of the movable coupling element is adaptable to the change in the speed differential.

This causes the movable coupling element to be moved toward the further coupling element precisely at the speed that is necessary to initiate an engagement of the coupling device at the point in time 5, so that the target rotational speed 3 is reachable as desired.

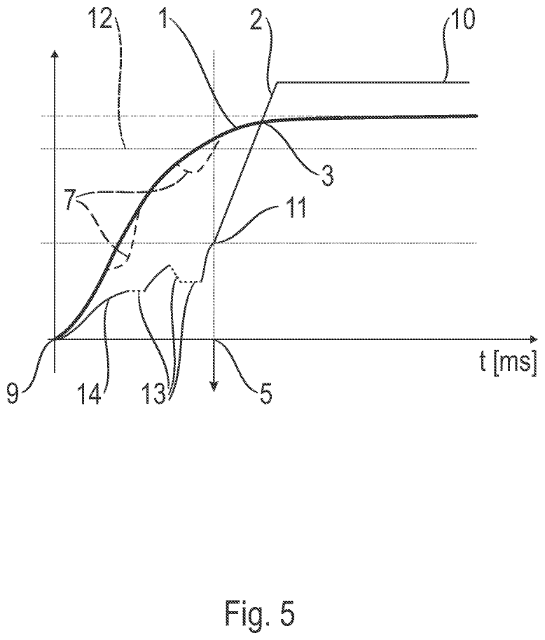

FIG. 5 shows other example aspects of the coupling process of the coupling device, wherein deviations 7 in the speed differential arise according to curve 1. The curve section 14 of the curve 2 is changeable according to corrections 13, in order to be able to flexibly respond to the arising deviations 7. The position of the movable coupling element is therefore controlled in a targeted manner by decelerating, accelerating, pausing, or reversing the movement of the movable coupling element, in order to always bring the coupling element in line with the change in the speed differential between the two coupling elements. If the speed differential adapts faster to the target rotational speed 3, the movement of the coupling element also takes place faster. If the speed differential changes more slowly or moves away from the target rotational speed 3, the movement of the movable coupling element is also able to be decelerated, paused, or reversed.

This means that the point in time 5, at which the engagement process is completely initiated, the displacement travel of the at least one movable coupling element is correctly selectable corresponding to the deviation 7, so that the actual exceedance of the limit speed 12 according to the correction 7 is usable as the point in time 5. The engagement process is therefore prevented from being carried out, even though the deviation 7 has resulted in a change in the speed differential, so that the engagement process is not sub-optimally performed, as in FIG. 1. Instead, the intermediate position of the coupling element is always selectable in line with the change in the speed differential. Therefore, the two coupling elements are movable toward each other and contact each other in the tooth-on-tooth position 11 precisely upon exceedance of the limit speed 12, so that an engagement process is performable once the target rotational speed 3 has been reached.

The coupling process and method described with reference to the figures are performable with a suitable coupling device. In some instances, the coupling device is an integral part of a motor vehicle. All advantages, details, and features are therefore transferrable to the motor vehicle and the coupling device. The advantages, details, and features shown in the individual exemplary embodiments are arbitrarily interchangeable with one another, combinable with one another, and transferrable to one another.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1, 2 curve
3 target rotational speed
4 synchronous speed
5 point in time
6 movement
7 deviation
8 intermediate position
9 starting position
10 end position
11 tooth-on-tooth position
12 limit speed
13 correction
14 section

1-10: (canceled)

11. A coupling device for a motor vehicle having a first rotatable part and a second rotatable part, the coupling device comprising:
a first coupling element associated with the first rotatable part, and
a second coupling element associated with the second rotatable part,
wherein the coupling device moves one or both of the first coupling element and the second coupling element into an intermediate position before a target rotational speed differential (3) between the first and the second coupling elements is reached, the target rotational speed differential (3) being reached before the coupling device moves the first coupling element and the second coupling element into form-lockingly coupling to couple the first and second rotatable parts.

12. The coupling device of claim 11, wherein the coupling device is moves the one or both of the first coupling element and the second coupling element into precisely one intermediate position (8) before the target rotational speed differential (3) is reached.

13. The coupling device of claim 11, wherein the intermediate position (8) is fixedly predefined by the coupling device.

14. The coupling device of claim 11, wherein the coupling device moves the one or both of the first coupling element and the second coupling element as a function of a speed differential between the first coupling element and the second coupling element before the target rotational speed differential (3) is reached.

15. The coupling device of claim 14, wherein the coupling device detects the speed differential and couples the first coupling element and the second coupling element when a limit speed (12) has been reached or fallen below.

16. The coupling device of claim 14, wherein the coupling device corrects, as the function of the speed differential, one or both of:
movement of one or both of the first coupling element and the second coupling element; and
the intermediate position (8) of one or both of the first coupling element and the second coupling element.

17. The coupling device of claim 11, wherein the coupling device detects a position of one or both of the first coupling element and the second coupling element.

18. The coupling device of claim 11, wherein the coupling device:
detects an arising dog intermediate condition between the first coupling element and the second coupling element, wherein the arising dog intermediate condition is one of a dog clamping or a tooth-on-tooth position; and
moves the one or both of the first coupling element and the second coupling element as a function of the arising dog intermediate condition.

19. The coupling device of claim 11, further comprising an actuator for moving the one or both of the first coupling element and the second coupling element.

20. A motor vehicle, comprising the coupling device of claim 11.

21. A method for coupling two coupling elements of a coupling device for a motor vehicle, the coupling device comprising a first coupling element having a first rotatable part of the motor vehicle, the coupling device further comprising a second coupling element having a second rotatable part of the motor vehicle, the method comprising:
setting a target rotational speed differential (3) between the first coupling element and the second coupling element;
moving one or both of the first coupling element and the second coupling element into at least one intermediate position (8) before the target rotational speed differential (3) is reached; and
moving the first coupling element and the second coupling element to form-lockingly couple after the one or both of the first coupling element and the second coupling element is brought into at the least one intermediate position (8).
